(19) United States
(12) Patent Application Publication
(10) Pub. No.: US 2005/0229740 A1
(43) Pub. Date: Oct. 20, 2005

(54) Vehicle steering wheel

(75) Inventor: Gregor Eck, Kirchzell (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 11/109,289

(22) Filed: Apr. 19, 2005

(30) Foreign Application Priority Data
Apr. 19, 2004 (DE) 20 2004 006 155.4

(51) Int. Cl. B62D 1/04

(52) U.S. Cl. 74/552

(57) ABSTRACT

A vehicle steering wheel has a skeleton (10) and an insert (16), housed in a receiving space (14) in the skeleton (10), to increase a mass moment of inertia. The accommodation space comprises walls (20, 22). The insert (16) is elastically bent by the walls (20,22) of the receiving space (14) abutting against it and is thereby tensioned clamped in the receiving space (16) and held therein.

### TECHNICAL FIELD

The invention relates to a vehicle steering wheel, with a skeleton and with an insert housed in a receiving space in the skeleton to increase the mass moment of inertia.

### BACKGROUND OF THE INVENTION

It is already known to house one or more inserts in particular in the region of the steering wheel rim in the skeleton. These inserts are either held on the skeleton by clip connections, or the skeleton is plastically deformed after insertion of the insert into the receiving space. However, in the dimensioning of the skeleton which, in contrast to the insert, represents the load-bearing part, it must be taken into consideration that it loses strength and rigidity because of the plastic deformation. Typical inserts are made of round steel and are calked with the skeleton.

The invention provides a vehicle steering wheel which is distinguished by a high stability and a simple manufacture.

### BRIEF SUMMARY OF THE INVENTION

This is achieved by a vehicle steering wheel according to the present invention which has a skeleton and an insert, housed in a receiving space in the skeleton, to increase a mass moment of inertia. The accommodation space is defined by walls. The insert is elastically bent by the walls of the receiving space abutting against it and is thereby tensioned and clamped in the receiving space and held therein.

Whereas in the prior art the skeleton is plastically deformed in order to embrace the insert, in accordance with the invention the insert itself is bent and tensioned by the more stable skeleton. A clip connection or other securing means for the insert thereby become unnecessary. Of course, on insertion of the insert and on the bending caused by the insertion, also a plastic deformation thereof can take place additionally. Despite the plastic deformation, however, the insert will still have sufficient elasticity in order to clamp itself in the receiving space in a pre-stressed manner. The insert has a higher density than the skeleton and is preferably made of metal, but not light metal.

The receiving space preferably has an open insertion opening for the insert, which also is not closed by a clip or the like. Only the casing of the steering wheel by foam and/or leather surrounds the skeleton and the insert.

In accordance with the preferred embodiment, the walls of the receiving space and the insert contact each other only partially, because gaps are to be provided between the contact points, which is intended to ensure the elastic deformation.

The contact areas are preferably defined by projections which are formed on the insert or, preferably, on the walls of the receiving space.

The preferred embodiment makes provision that the skeleton runs in a closed ring-shape in the steering wheel rim and the insert sits in the steering wheel rim, i.e. in the part of the steering wheel skeleton which passes through the steering wheel rim.

The insert can be a ring which extends in the ring-shaped skeleton along the steering wheel rim. This ring can extend in a closed manner and in this case would form a unit together with the skeleton and would distinctly increase the stability of the steering wheel rim.

Viewed in radial cross-section, the skeleton has a U-shaped, circumferential form in the region of the steering wheel rim. Between the arms of the “U”, the insert is then pressed in.

It is particularly advantageous if the insert extends, elastically bent in an undulating shape in the ring-shaped receiving space along the steering wheel rim. This makes provision that numerous contact points are produced and the insert is bent several times in various directions, which improves its pre-stressing effect.

It is particularly advantageous if the insert has a rectangular cross-sectional profile, seen in a radial section. In this case radial means in relation to the steering wheel hub or steering shaft, which extends through the hub.

### BRIEF DESCRIPTION OF THE DRAWINGS

FIG. 1 shows a top view onto a vehicle steering wheel according to the invention,

FIG. 2 shows a radial sectional view through the steering wheel rim along the line II-II in FIG. 1, and

FIG. 3 shows a view of a section of the steering wheel rim from below without the foam and with the insert fastened to the skeleton.

### BRIEF DESCRIPTION OF THE PREFERRED EMBODIMENT

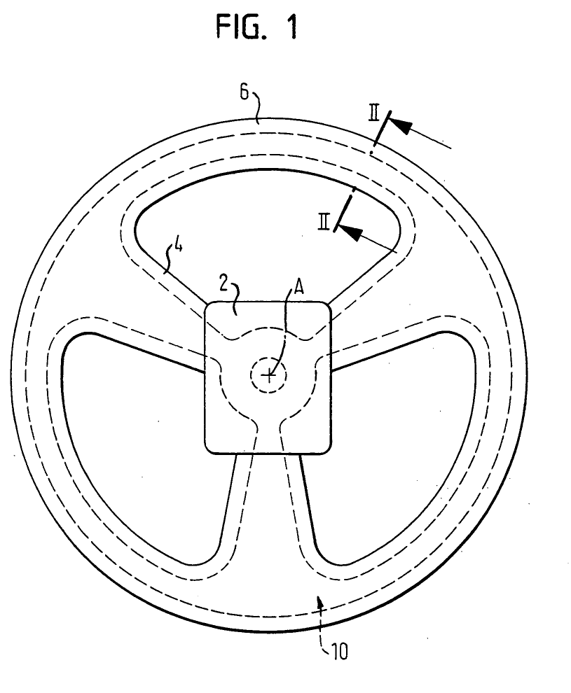

In FIG. 1 a vehicle steering wheel is illustrated, which has a hub 2, extending around the steering wheel axis A, spokes 4 and a steering wheel rim 6 having the shape of a circular ring. The steering wheel is a composite component and has, on the outside, a skin of foam or leather. A wood casing or the like is also conceivable.

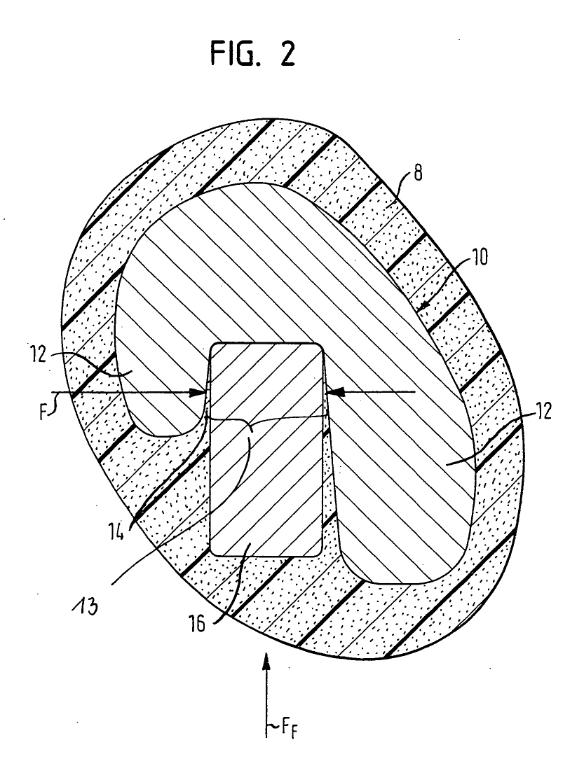

In FIG. 2 the outer foam layer 8 can be seen better. The stability of the steering wheel is achieved by a steering wheel skeleton 10 in a single piece, provided in its interior, which is illustrated by broken lines in FIG. 1. The steering wheel skeleton 10 has a section having the shape of a circular ring in the steering wheel rim 6 and spoke sections which extend from the steering wheel rim section to a hub section.

In particular, the steering wheel skeleton 10 is a die cast metal part. It preferably has a U-shaped cross-section, to be seen in section in accordance with FIG. 2, in the region of the steering wheel rim 6, the “U” being open to the bottom (shown) or to the top and being delimited by two arms 12. In the region of the spoke inlets, the U-shaped profile is usually interrupted. Between the arms 12, a continuously receiving space 14 is produced, passing along the steering wheel rim 6 and provided with a downwardly open insertion opening, into which receiving space the insert 16 is pressed. The insert 16 is a ring which is encircling in a closed form or slotted, which is inserted into the steering wheel rim 6 to increase the mass moment of inertia. Alternatively, of course also several inserts could be provided, forming ring segments, spaced apart peripherally.

The insert 16 is only held in the receiving space 14 by a lateral clamping force F which is exerted onto it by the arms 12.

This clamping force is produced in that the insert, which has further a rectangular cross-sectional profile, is pressed into the skeleton 10 from below between the arms 12 and the insertion opening 13 formed thereby, and is hereby deformed elastically and if necessary also additionally slightly plastically in a plane perpendicular to the axis A and transversely to the peripheral direction.

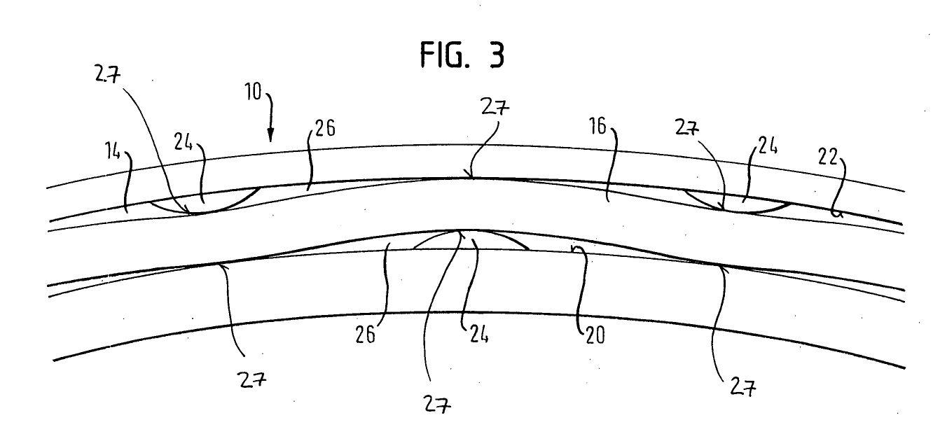

The receiving space 14, as can be seen in FIG. 3, runs substantially in a circular ring shape. However, it has rounded projections 24 in peripheral direction alternately on the inner wall 20 and the outer wall 22. The insert 16 abuts against the projections 24, and between the projections 24 gaps 26 are produced between the inner or outer wall 20, 22 and the insert 16. The contact areas, on which either the walls 20, 22 or the projections 24 and the insert 16 touch each other, are reverenced by 27. Because of the projections 24, the insert 16 is bent in an undulating shape several times inwards and outwards, so that a radial pre-stressing force is produced, by which only the insert 16 is clamped and held in the receiving space 14.

Alternatives to these features are that groups of several projections 24 are provided alternately firstly on the inner wall and then on the outer wall 20, 22 and the groups alternate with each other.

Instead of an undulating shape, the insert can also be composed from sections which are curved differently radially outwards in convex shape in axial view.

The joining of skeleton 10 and insert 16 takes place only through the application of an axial force F_{F} (see FIG. 2).

Because of the invention, the following advantages result among other things:

As no, or only a slight, plastic deformation occurs in the insert, the joining is able to be used so as to be protective to the material and largely neutral as regards the material, and is also moderately priced.

Very high mass moments of inertia can be achieved by high-volume inserts 16, because the structural space can be better utilized by the rectangular profile, in contrast to the round profiles known hitherto, owing to the space-saving fastening.

The fastening of the insert 16 and its profile have a positive influence on the rigidity and the strength of the steering wheel rim 6, because the skeleton profile can be better constructed in the region of the steering wheel rim 6 with regard to an increased rigidity than with the use of an insert 16 having a round profile.

1. A vehicle steering wheel, said vehicle steering wheel comprising
a skeleton (10) and
an insert (16), housed in a receiving space (14) in said skeleton (10), to increase a mass moment of inertia,
said accommodation space being defined by walls (20, 22) and
said insert (16) being elastically bent by said walls (20,22) of said receiving space (14) abutting against it and thereby being tensioned and clamped in said receiving space (16) and held therein.

2. The vehicle steering wheel according to claim 1, wherein said receiving space (14) has an open insertion opening (13) for said insert (16).

3. The vehicle steering wheel according to claim 1, wherein said walls (20, 22) of said receiving space (14) and said insert (16) contact each other partially to form contact areas (27) and wherein gaps (26) are provided between said contact areas (27).

4. The vehicle steering wheel according to claim 3, wherein said insert (16) comprises opposite sides, said sides having said contact areas (27) which, when viewed in longitudinal direction of the insert (16), alternate in peripheral direction.

5. The vehicle steering wheel according to claim 3, wherein said contact areas (27) are formed by projections (24).

6. The vehicle steering wheel according to claim 5, wherein said projections (24) are formed on said walls (20, 22) of said receiving space (14).

7. The vehicle steering wheel according to claim 1, wherein said steering wheel comprises a steering wheel rim (6), wherein said skeleton (10) runs in a closed ring shape in said steering wheel rim (6) and wherein said insert (16) sits in said steering wheel rim (6).

8. The vehicle steering wheel according to claim 1, wherein said insert (16) is a ring which extends in said ring-shaped skeleton (10) along said steering wheel rim (6).

9. The vehicle steering wheel according to claim 1, wherein said skeleton (10) has a U-shaped profile in the region of said steering wheel rim (6), when viewed in radial cross-section, with arms, and wherein said insert (16) is clamped between said arms (12).

10. The vehicle steering wheel according to claim 1, wherein said insert (16) extends, bent elastically in an undulating shape, in said ring-shaped receiving space (14), along said steering wheel rim (6).

11. The vehicle steering wheel according to claim 1, wherein said insert (16) has a rectangular cross-sectional profile.
